(19) United States
(12) Patent Application Publication
(10) Pub. No.: US 2007/0103817 A1
(43) Pub. Date: May 10, 2007

(54) Disk drive

(76) Inventor: John L. Rogitz, San Diego, CA (US)

Correspondence Address: ROGITZ & ASSOCIATES, 750 B STREET, SUITE 3120, SAN DIEGO, CA, 92101, US

(21) Appl. No.: 11/270,032

(22) Filed: Nov. 9, 2005

(51) Int. Cl. G11B 5/48; G11B 21/16

(52) U.S. Cl. 360/244

(57) ABSTRACT

A disk drive includes a disk, a suspension juxtaposed with the disk, and plural sliders arranged in a row on the suspension.

### FIELD OF THE INVENTION

The invention relates to disk drives, including hard disk drives and optical drives.

### BACKGROUND

Disk drives such as hard disk drives store data in concentric tracks on disks. To read the data, a read head on the end of a suspension is moved over the relevant track, and then as the disk spins and the part of the track containing the desired data moves under the read head, the read head magnetically or optically senses the data and sends a signal to a drive controller. Data may be written to disk using a write head that likewise is moved over the track to which data is sought to be written.

Two components of data transfer delay (“latency”) thus exist: the delay in moving the head over the desired track, and then the delay in waiting for the correct segment of the track to rotate under the head. The present invention is directed to shortening, if not eliminating, the former.

### SUMMARY OF THE INVENTION

A disk drive includes a disk, a suspension juxtaposed with the disk, and plural sliders arranged in a row on the suspension. The disk drive can be an optical drive or a hard disk drive (HDD). The row may be linear or curved. One slider per data track on the disk may be provided, in which case the suspension need not be movable in the disk drive. Or, one slider per group of adjacent data tracks on the disk may be provided, in which case the suspension is movable in the disk drive. A multiplexer can be electrically connected to the sliders and a controller can be connected to the multiplexer. Each slider may include a read head and a write head, and only one suspension with sliders thus need be provided per surface of the disk. Or, each slider may include a read head only, in which case a second suspension that supports a row of write heads can be juxtaposed with the disk.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a partially schematic diagram of a first embodiment of the disk drive;

FIG. 2 is a partially schematic diagram of a second embodiment of the disk drive; and

FIG. 3 is a schematic top plan view showing a suspension with a spiral shape, superimposed on a disk shown in phantom.

### DETAILED DESCRIPTION OF THE PREFERRED EMBODIMENT

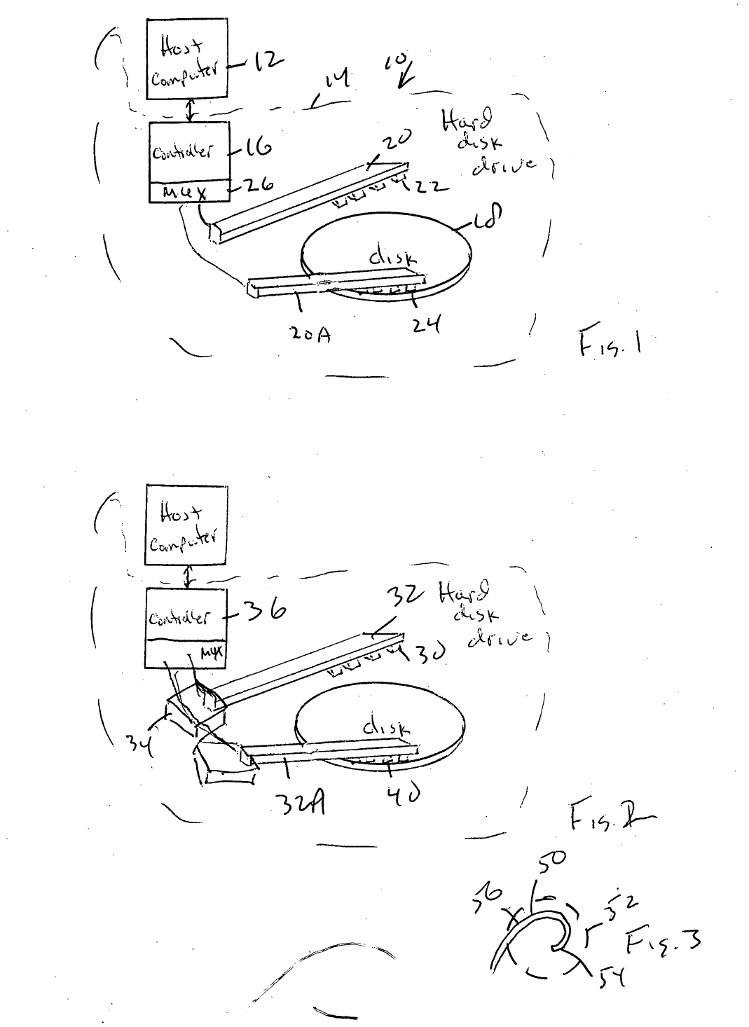

Referring to FIG. 1, a magnetic or optical disk drive is shown, generally designated 10, for exchanging data with a host computer 12. The disk drive 10 can include a housing 14 and a controller 16. The disk drive 10 also includes at least and usually several disks 18, and at least one suspension 20 is juxtaposed with each disk 18. In one implementation, a first suspension 20 supports plural (i.e., at least two) sliders 22 that are arranged in a curved row or straight row along the long axis of the suspension. By “row” is meant that the sliders 22 are in a radial sequence relative to the disk, that is, no two sliders occupy the same radial position relative to the disk. The row may be straight or curved as stated, and the sliders may be slightly staggered or azimuthally offset from each other in the transverse dimension of the suspension.

Each slider 22 can include a read head and a write head, in which case only one suspension 20 per disk surface need be provided. Or, each slider 22 may include only a read head, in which case a second suspension 20A may be provided and may include plural write heads 24 arranged in a curved or straight line. The controller 16 is connected to each slider/head through a multiplexing mechanism 26.

According to the present invention, neither suspension 20, 20A moves. Accordingly, no motor is provided for moving the sliders/heads, which consequently are stationary throughout operation in the housing 14. Taking the sliders 22 as examples, a respective slider 22 is formed on the suspension 20 for each data track on the disk 18 in a one-to-one relationship. The suspension 20 is positioned relative to the disk such that one slider 22 is fixedly positioned above each data track of the disk. During operation, it is not necessary to reposition sliders. Instead, the controller 16 simply cooperates with the multiplexer 26 to receive and/or send signals to the slider 22 that is associated with the data track of the information sought to be read or written, eliminating repositioning latency. When the sliders 22 are read head only sliders and the second suspension 20A with write heads 24 is provided, each write head 24 likewise is positioned over a respective data track. Not only is repositioning latency eliminated, but it is possible to simultaneously read and write data to different tracks or indeed to the same track when a separate second suspension 22A is provided.

Or, both suspensions 20, 20A can include read heads, with the read heads of one suspension being positioned over every odd numbered track and the read heads of the other suspension being positioned over every even numbered track, with the total number of read heads on each suspension thus equalling one-half the number of data tracks on the disk. More than two suspensions may be provided, space permitting, in accordance with these principles.

FIG. 2 shows that it may not be necessary to provide one slider per data track, but instead provide a straight or curved line of sliders 30 on a suspension 32 in which the spacing between adjacent sliders is, e.g., two data tracks, or three data tracks, or some other spacing greater than a single data track. In this case, each slider 32 may be correlated with a respective group of two or more adjacent data tracks, and the suspension 32 is moved by a motor 34 under control of a controller 36 as appropriate to position a slider over the relevant track. While repositioning latency thus is not totally eliminated, it is greatly reduced because any one slider need be moved at most only a small distance. As was the case with the embodiment of FIG. 1, the sliders 30 in FIG. 2 may include both read and write heads, or they may include only read heads, in which case a second suspension 32A with plural write heads 40 is provided. In any case, the sliders on a suspension are all operational (as opposed to being spares) for exchanging data only with their respective subset of tracks.

FIG. 3 shows a non-limiting example of a suspension 50 that is spiral shaped, extending almost all the way around a disk 52 such that the Cartesian spacing between adjacent sliders is greater than the spacing between them in the radial dimension. One location 54 (and, hence, a slider that is positioned there) on the suspension 50 is located over the inner diameter of the disk and another location 56 is located over the outer diameter of the disk.

While the particular disk drive as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A disk drive, comprising:
at least one disk;
at least one suspension juxtaposed with the disk; and
plural sliders arranged in a row on the suspension, the sliders all being operational to exchange data with respective tracks on the disk.

2. The disk drive of claim 1, wherein the disk drive is an optical drive.

3. The disk drive of claim 1, wherein the disk drive is a hard disk drive (HDD).

4. The disk drive of claim 1, wherein the row is linear.

5. The disk drive of claim 1, wherein the row is curved.

6. The disk drive of claim 1, comprising one slider per data track on the disk, the suspension not being movable in the disk drive.

7. The disk drive of claim 1, comprising one slider per group of adjacent data tracks on the disk, the suspension being movable in the disk drive.

8. The disk drive of claim 1, comprising a multiplexer electrically connected to the sliders.

9. The disk drive of claim 8, comprising a controller connected to the multiplexer.

10. The disk drive of claim 1, wherein each slider includes a read head and a write head, and only one suspension with sliders is provided per surface of the disk.

11. The disk drive of claim 1, wherein the suspension is a first suspension, each slider includes a read head only, and a second suspension supporting a row of write heads is juxtaposed with the disk.
